(19) United States
(12) Patent Application Publication
(10) Pub. No.: US 2011/0210645 A1
(43) Pub. Date: Sep. 1, 2011

(54) DOWNHOLE STATIC POWER GENERATOR

(75) Inventor: Stephen D. Mason, Katy, TX (US)

(73) Assignee: SCHLUMBERGER TECHNOLOGY CORPORATION, SUGAR LAND, TX (US)

(21) Appl. No.: 12/714,924

(22) Filed: Mar. 1, 2010

(51) Int. Cl. H02N 1/04

(52) U.S. Cl. 310/309

(57) ABSTRACT

A downhole static power generator according to one or more aspects of the present disclosure comprises a static charge accumulator comprising a dielectric material having a surface to contact a flowing dielectric fluid. The static charge accumulator may be configured to accumulate electrical-potential in response to the dielectric fluid flowing across the surface. In addition, an electrical-potential storage device may be provided to receive the electrical-potential from the static charge accumulator. A charge harvesting device may also be provided to shunt electrical-potential from the static charge accumulator to the electrical-potential storage device.

### BACKGROUND

This section provides background information to facilitate a better understanding of the various aspects of the present invention. It should be understood that the statements in this section of this document are to be read in this light, and not as admissions of prior art.

A typical subterranean well includes various devices that are operated by mechanical motion, hydraulic power or electrical power. For devices that are operated by electrical or hydraulic power, control lines and/or electrical cables typically extend downhole for purposes of communicating power to these tools from a power source that is located at the surface. A potential challenge with this arrangement is that the space (inside the wellbore) that is available for routing various downhole cables and hydraulic control lines is limited. Furthermore, the more hydraulic control lines and electrical cables that are routed downhole, the higher probability that some part of the power delivery infrastructure may fail. Other risks are inherent in maintaining the reliability of any line or cable within the well's hostile chemical, mechanical or thermal environment and over the long length that may be required between the surface power source and the downhole power operated device.

Thus, some subterranean well systems utilize electrical storage devices, such as batteries, to operate selected devices. Also, some well systems utilize a downhole power source to generate electrical power downhole. For example, some power generators have been provided that convert vibration energy into electricity, while other downhole power generators convert pressure fluctuations into electrical power.

Thus, there is a continuing desire to provide apparatus and techniques for providing electrical power downhole. There is a still further desire to provide electrical power generation that does not require moving parts. It is a still further desire to provide a downhole electrical power generator that that does not adversely impact the ability to produce a fluid from and/or inject a fluid into a well.

### SUMMARY

A downhole static power generator according to one or more aspects of the present disclosure comprises a static charge accumulator comprising a dielectric material having a surface to contact a flowing dielectric fluid. The static charge accumulator accumulates electrical-potential in response to the dielectric fluid flowing across the surface. An electrical-potential storage device may be provided to receive the electrical-potential from the static charge accumulator. Additionally, a charge harvesting device may be provided to shunt electrical-potential from the static charge accumulator to the electrical-potential storage device.

According to one or more aspects of the present disclosure, a system for use in a subterranean well comprises an electrical power consuming device disposed in the well. A static power generator may be located downhole in the well and electrically connected to the electrical power consuming device. The static power generator may provide electrical-potential to the electrical power consuming device in response to a dielectric fluid flowing across the static power generator.

A method, according to one or more aspects of the present disclosure, for providing electrical power in a subterranean well comprises accumulating electrical-potential in response to a dielectric fluid flowing in the subterranean well and providing the accumulated electrical-potential to an electrical power consuming device. The method may comprise shunting the accumulated electrical-potential to an electrical-potential storage device. The method may comprise producing a formation fluid comprising the dielectric fluid and a conductive fluid and separating the dielectric fluid from the conductive fluid.

The foregoing has outlined some of the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

The present disclosure is best understood from the following detailed description when read with the accompanying figures. It is emphasized that, in accordance with standard practice in the industry, various features are not drawn to scale. In fact, the dimensions of various features may be arbitrarily increased or reduced for clarity of discussion. The figures are as follows:

FIG. 1 is a schematic diagram of a well comprising a downhole static power generator according to one or more aspects of the present disclosure;

FIG. 2 is a schematic illustration of a bottom-hole assembly and downhole static power generator according to one or more aspects of the present disclosure; and

FIG. 3 is a schematic view of a static power generator according to one or more aspects of the present disclosure.

### DETAILED DESCRIPTION

It is to be understood that the following disclosure provides many different illustrative embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

Those skilled in the art, given the benefit of this disclosure, will appreciate that the disclosed apparatuses and methods have applications in operations other than drilling and/or well production. While this disclosure is described in relation to well production and drilling operations, the disclosed apparatus and methods may be applied to other operations including without limitation injection techniques and pipelines. As used herein, the terms “up” and “down”; “upper” and “lower”; “top” and “bottom”; and other like terms indicating relative positions to a given point or element are utilized to more clearly describe some elements. Commonly, these terms relate to a reference point as the surface from which drilling operations are initiated as being the top point and the total depth of the well being the lowest point, wherein the well (e.g., wellbore, borehole) is vertical, horizontal or slanted relative to the surface. The terms “pipe,” “tubular,” “tubulars,” “tubular string,” “casing,” “liner,” tubing,” “drill pipe,” “drill string” and other like terms can be used interchangeably.

In this disclosure, “hydraulically coupled” or “hydraulically connected” and similar terms, may be used to describe bodies that are connected in such a way that fluid pressure may be transmitted between and among the connected items. The term “in fluid communication” is used to describe bodies that are connected in such a way that fluid can flow between and among the connected items. It is noted that hydraulically coupled may include certain arrangements where fluid may not flow between the items, but the fluid pressure may nonetheless be transmitted. Thus, fluid communication is a subset of hydraulically coupled.

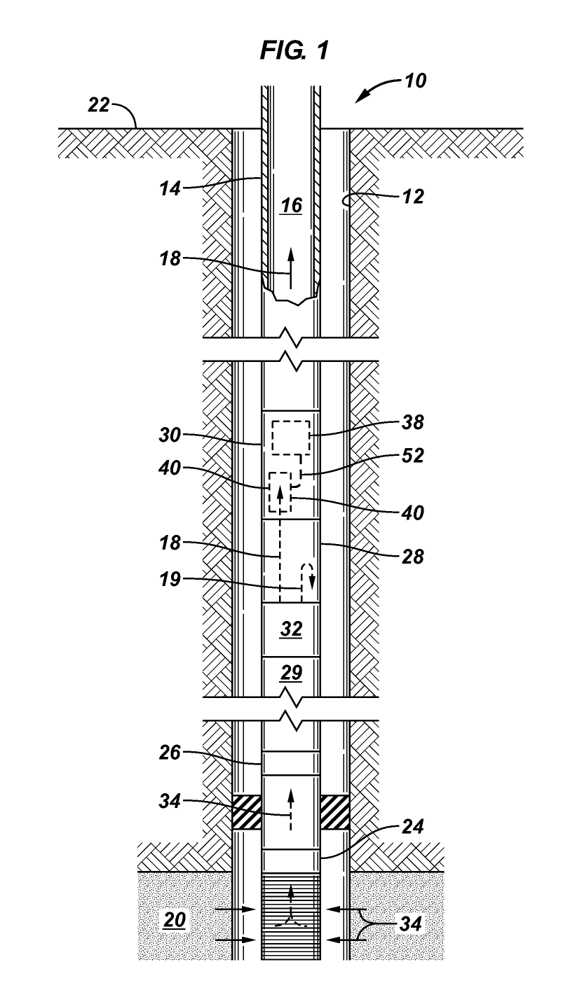

FIG. 1 is a schematic diagram of a static power harvesting system 10, according to one or more aspects of the present disclosure, disposed in a well 12 (e.g., wellbore, borehole). In the depicted embodiment a tubular string 14 having a fluid passageway 16 is disposed in well 12. In the embodiment depicted in FIG. 1, tubular string 14 is a production string through which fluid 18 is produced from a subterranean geological formation 20 to the surface 22. In the depicted embodiment, fluid 18 is a hydrocarbon based liquid (e.g., oil) which has a low conductivity or is substantially non-conductive (e.g., dielectric). As is commonly encountered in well production systems, dielectric fluid 18 is not necessarily all oil, but will typically comprise a percentage of water.

Depicted static power harvesting system 10 comprises one or more electrical power consuming devices, generally denoted by the numeral 29, such as, and without limitation to, sensors, telemetry systems (transmitters and/or receivers), actuators, microprocessors, Micro Electrical Mechanical Sensors (“MEMS”), logging instruments and pumps (e.g., electrical submersible pump). For example, static power harvesting system 10 of FIG. 1 comprises a valve 24, sensor 26 (e.g., pressure sensor, temperature sensor, flow rate sensor, fluid analyzer, etc.) and a downhole controller 28 (e.g., intelligent controller, microprocessor, processor). One or more of these electrically powered devices may be connected to a static power generator 30 which is disposed downhole.

Downhole controller 28 can comprise circuitry that controls downhole equipment independent from commands that may be communicated from surface 22 of the well. For example, valve 24 (e.g., safety valve, ball valve, sliding sleeve, etc.) may be actuated pursuant to commands from controller 28 and/or utilizing electrical power supplied via static power generator 30. Downhole controller 28 may be utilized for example to shunt (e.g., transfer) the electrical charge potential from a static charge accumulator 40 (FIG. 3) to an electrical-potential storage device 38. Depicted sensor 26 may include, for example, one or more of a pressure sensor, a temperature sensor, a fluid composition sensor and a Micro Electrical Mechanical Sensor (MEMS). In one example, downhole controller 28 may be utilized to operate valve 24 and/or fluid separator 32 in response to one or more characteristics detected and/or measured by sensor 26.

The flow of dielectric fluid 18 is the primary source of static energy that is converted into downhole electrical power by static power generator 30 for use by one or more of the electrical consuming devices. In the depicted embodiment, static power generator 30 does not use vibrating or moving parts to generate electrical power.

As will be further described below, static power generator 30 captures (e.g., harvests) static electricity associated with the flow of the dielectric fluid 18. In some embodiments, for example as depicted in FIG. 1, static power harvesting system 10 may comprise a fluid separator 32 to ensure that dielectric fluid 18, which flows through (e.g., across) static power generator 30 is the dielectric portion (e.g., primarily oil portion) of the formation fluid 34. For example, formation fluid 34 comprising water and oil is produced from formation 20 into well 12 and into fluid passageway 16 of tubular string 14. As formation fluid 34 flows to surface 22 it passes through fluid separator 32 wherein a primarily oil stream from formation fluid 34 is routed across static charge accumulator 40 of static power generator 30 as dielectric fluid 18. The primarily water portion 19 (e.g., conductive portion) separated from formation fluid 34 in fluid separator 32 is routed away from or around static power generator 30, for example for disposal (e.g., injection) into geological formation (not shown) which may intersected by well 12 and located above or below formation 20 relative to surface 22. Examples of some present and prior high quality downhole oil-water separation systems are disclosed in U.S. Pat. No. 5,961,841 and U.S. Patent Application Publication Nos. 2009/0242197 and 2009/0056939 which are incorporated herein by reference.

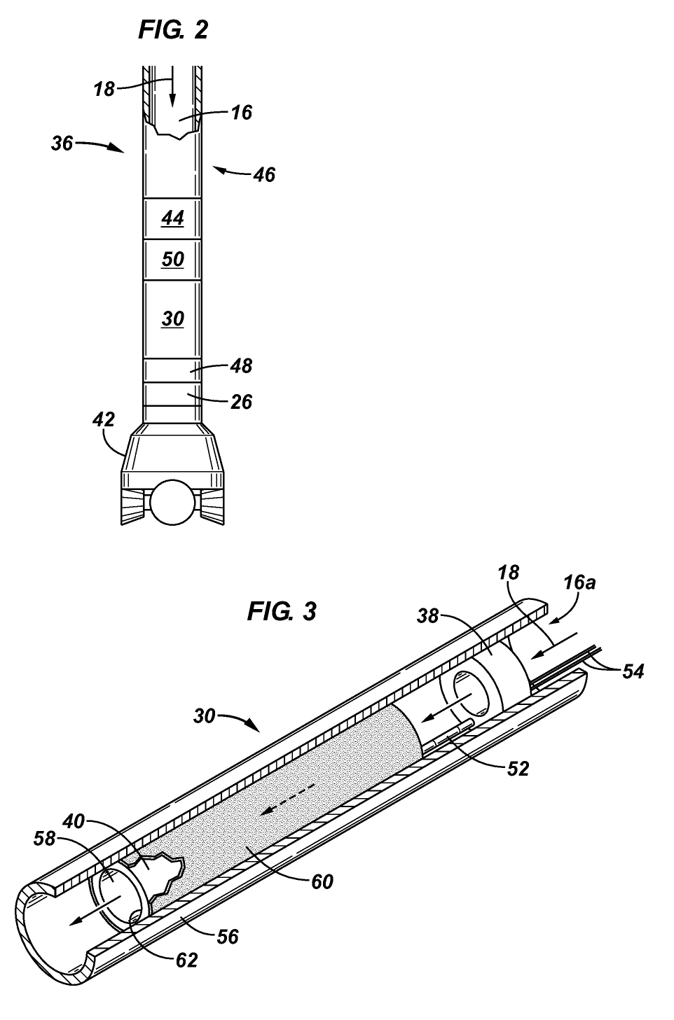

FIG. 2 is a schematic illustration of a bottom-hole assembly 36 (“BHA”) including a static power generator 30 according to one or more aspects of the present disclosure. Bottom-hole assembly 36 comprises a drill bit 42, sensor 26 and mud motor 44 disposed at the lower end of a drill string 46. Depicted bottom-hole assembly 36 also comprises an electronic instrument 48 and a telemetry package 50. Electronic instrument 48 may comprise, for example, a measurement-while-drilling tool and/or a logging-while-drilling tool. BHA 36 comprises a fluid passageway 16 through which a drilling fluid 18 (e.g., mud) may be circulated to operate motor 44. According to one or more aspects of the present disclosure, drilling fluid 18 is a dielectric fluid, such as an oil-based drilling mud. Static power generator 30 is connected to one or more of the electrical consuming devices, such as sensors 26 and instrument 48. Utilization of static power generator 30 provides a mechanism to supply electrical power to various devices, such as sensor 26 and/or instrument 48 without having to route cables around mud motor 44 for example and permit the desired placement of sensor 26 adjacent to drill bit 42.

FIG. 3 is a schematic diagram of a static power generator 30 according to one or more aspects of the present disclosure. Depicted static power generator 30 comprises static charge accumulator 40 connected to electrical-potential storage device 38 via a charge harvesting device 52 (e.g., switch, circuit, shunt). One or more electrical conduits 54 may connect static power generator 30 via electrical-potential storage device 38 to one or more of the electrical consuming devices 29, such as electrical consuming devices 24, 26, 28, 48 and 50 depicted in FIGS. 1 and 2.

Depicted static power generator 30 further comprises a tubular housing 56 which is conceptually depicted in FIG. 3. Tubular housing 56 includes a fluid passageway 16a through which dielectric fluid 18 flows. Fluid passageway 16a is in fluid communication with fluid passageway 16 of tubular string 14 depicted in FIG. 1 and fluid passageway 16 of BHA 36 depicted in FIG. 2. Static charge accumulator 40 is in fluid communication with fluid passageway 16 depicted in FIGS. 1 and 2 and may be physically disposed within the fluid passageway 16 or physically offset from fluid passageway 16 for example in a side pocket or the like.

As will be understood by those skilled in the art with reference to the present disclosure, housing 56 may be a tubular member, such as for example, a pipe joint, sub or drill collar which is connected within a tubular string or bottom-hole assembly. Tubular housing 56 may be constructed of an electrically conductive material.

Static charge accumulator 40 is constructed of a dielectric material which accumulates an electrical charge (e.g., triboelectric charging) in response to the flow of dielectric fluid 18 across a contact surface 58. For example, static charge accumulator 40 may be constructed of material such as adapted for triboelectric charging, such as, and without limitation, to plastics, synthetic rubbers, and carbon fiber materials. Other examples include, without limitation, polyvinyl chloride (“PVC”), carbon fiber vinyl, silicon, polyethelene, polyurethane and polytetrafluorethylene (i.e., TEFLON). Static charge accumulator 40 is electrically shielded from housing 56, for example, by an electrical insulation 60. Thus, static charge accumulator 40 is electrically isolated from ground. As dielectric fluid 18 flows across surface 58 of static charge accumulator 40, static charge (e.g., electrical-potential) accumulates on static charge accumulator 40 in response to the transfer of electrons between contact surface 58 of static charge accumulator 40 and dielectric fluid 18. Static charge accumulator 40 may be capable of accumulating a high-voltage, for example greater than 1,000,000 volts. The electrical-potential (e.g., charge) accumulation on static charge accumulator 40 may be determined by the material of construction of static charge accumulator 40, the surface area of contacting surface 58, and/or the flow rate of dielectric fluid 18 across contact surface 58. Additional considerations for constructing static power generator 30, including static charge accumulator 40, include the ambient conditions of the operating environment (e.g., temperature, pressure) as well as the composition of dielectric fluid 18.

Charge harvesting device 52 periodically shunts the electrical-potential from static charge accumulator 40 to electrical-potential storage device 38. The activation of charge harvesting device may be autonomic, automatic or manual and may be performed in response to one or more parameters or characteristics. For example, and without limitation, shunting (e.g., transferring) electrical-potential from static charge accumulator 40 to electrical-potential storage device 38 may be selected based upon the storage capacity of electrical-potential storage device 38 and/or on the electrical consumption requirements or needs of the electrical device or devices utilizing power from static power generator 30. Charge harvesting device 52 must be isolated from electrical ground to transfer the electrical-potential from static charge accumulator 40 to electrical-potential storage device 38. In some embodiments, charge harvesting device 52 is a solid state electronic device having circuitry controlling the transfer of electrical-potential between static charge accumulator 40 and electrical-potential storage device 38. In some embodiments, charge harvesting device 52 is in connection with an independent controller, such as downhole controller 28 (FIG. 1), which commands the activation of charge harvesting device 52 and the transfer of electrical-potential from static charge accumulator 40 to electrical-potential storage device 38. In some embodiments, charge harvesting device 52 may comprise a mechanical device that electrically connects static charge accumulator 40 to electrical-potential storage device 38 for example in response to harmonic pulsations.

Electrical-potential storage device 38 may be a device or substrate that is adapted to collect and store energy produced by static power generator 30. Electrical-potential storage device 38 is depicted disposed in housing 56, however, it is understood that electrical-potential storage device 38 may be physically positioned in one or more locations proximate to or distal from housing 56. Electrical-potential storage device 38 may take various forms, such as and without limitation to, one or more traditional chemical battery, one or more capacitors and a combination of batteries and capacitors. In some embodiments, static power generator 30 may be a standalone tool that can be electrically connected, for example via charge harvesting device 52, to an electrical-potential storage device 38 (such as a battery) that is incorporated in another wellbore tool.

Static charge accumulator 40 is depicted as a tubular member in FIG. 3 having a bore 62 through which dielectric fluid 18 flows. Bore 62 is defined by contacting surface 58 of static charge accumulator 40 in this embodiment. In the depicted embodiment electrical-potential storage device 38 may provide a passageway through which fluid 18 is permitted to flow or may be offset from the fluid flow path, for example by placement in a wall of a drill collar or the like. In the depicted embodiment, dielectric fluid 18 flows through the internal passageway of static charge accumulator 40. However, a tubular shaped static charge accumulator 40 may be positioned in housing 56 such that fluid 18 flows across both the internal surface and the external surface of static charge accumulator 40, each of which may be a contacting surface 58.

It is emphasized that FIG. 3 is a schematic illustration of an embodiment of static power generator 30 and static charge accumulator 40 and the dimensions and configurations are not limited to the illustrated embodiments. For example, static charge accumulator 40 may comprise one or more tubular members and/or one or more non-tubular dielectric members. For example, a non-tubular member may comprise a planar member or a member that does not have a planar surface and does not form a bore (e.g., passageway). Static charge accumulator 40, as previously noted, may comprise one or more members, each of which may have one or more contacting surfaces 58 across which dielectric fluid 18 flows. In one embodiment, static charge accumulator 40 comprises more than one tubular dielectric member disposed so that dielectric fluid 18 flows across at least two contacting surfaces of one or more of the tubular members. For example, a second tubular member may be disposed inside of the tubular member of static charge accumulator 40 depicted in FIG. 3. Dielectric fluid 18 may flow across the contact surface 58 defining bore 62 of FIG. 3 as well as the outer surface and the inner surface of the second tubular member.

According to one or more aspects of the present disclosure, a system for use in a subterranean well the system comprises an electrical power consuming device disposed in the well. Additionally, a static power generator may be located downhole in the well and electrically connected to the electrical power consuming device. The static power generator may be configured to provide electrical-potential to the electrical power consuming device in response to a dielectric fluid flowing across the static power generator.

The power generator comprises a static charge accumulator comprising a dielectric material. The dielectric material may include polyvinyl chloride. The dielectric material may be primarily oil. The static power generator and the electrical power consuming device may be electrically connected through an electrical-potential storage device. The system may further include a fluid separator in fluid communication with the static power generator.

In at least one embodiment the static power generator comprises a static charge accumulator comprising a dielectric material having a surface in contact with the flowing dielectric fluid. Additionally, an electrical-potential storage device may be provided to receive the electrical-potential from the static charge accumulator. The dielectric material may comprise polyvinyl chloride. The static charge accumulator may comprise a tubular shaped member. A fluid separator may be in fluid communication with the static power generator.

In at least one embodiment the static power generator comprises a static charge accumulator comprising a dielectric material having a surface in contact with the flowing dielectric fluid. Additionally, an electrical-potential storage device may be provided to receive the electrical-potential from the static charge accumulator. A charge harvesting device may also be provided to shunt electrical-potential from the static charge accumulator to the electrical-potential storage device. The dielectric material may comprise polyvinyl chloride. The static charge accumulator may comprise a tubular shaped member. In at least one embodiment, the static charge accumulator comprises a tubular shaped member having a fluid passageway to pass the flowing dielectric fluid.

A method, according to one or more aspects of the present disclosure, for providing electrical power in a subterranean well comprises accumulating electrical-potential in response to a dielectric fluid flowing in the subterranean well. In addition, the method may include providing the electrical-potential to an electrical power consuming device. The method may also comprise shunting the accumulated electrical-potential to an electrical-potential storage device. Additionally, the method may comprise producing a formation fluid comprising the dielectric fluid and a conductive fluid, and separating the dielectric fluid from the conductive fluid.

A downhole static power generator according to one or more aspects of the present disclosure comprises a static charge accumulator comprising a dielectric material having a surface to contact a flowing dielectric fluid, wherein the static charge accumulator accumulates electrical-potential in response to the dielectric fluid flowing across the surface. Additionally, an electrical-potential storage device may be provided to receive the electrical-potential from the static charge accumulator. A charge harvesting device may also be provided to shunt electrical-potential from the static charge accumulator to the electrical-potential storage device. In one embodiment the static charge accumulator comprises a tubular shaped member having a fluid passageway defined by the surface, wherein the dielectric material comprises polyvinyl chloride.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure. The scope of the invention should be determined only by the language of the claims that follow. The term “comprising” within the claims is intended to mean “including at least” such that the recited listing of elements in a claim are an open group. The terms “a,” “an” and other singular terms are intended to include the plural forms thereof unless specifically excluded.

What is claimed is:

1. A system for use in a subterranean well, the system comprising:
an electrical power consuming device disposed in the well; and
a static power generator located downhole in the well and electrically connected to the electrical power consuming device, the static power generator to provide electrical-potential to the electrical power consuming device in response to a dielectric fluid flowing across the static power generator.

2. The system of claim 1, wherein the static power generator comprises a static charge accumulator formed of a dielectric material.

3. The system of claim 2, wherein the dielectric material comprises polyvinyl chloride.

4. The system of claim 1, wherein the dielectric fluid comprises primarily oil.

5. The system of claim 1, wherein the static power generator and the electrical power consuming device are electrically connected through an electrical-potential storage device.

6. The system of claim 1, further comprising a fluid separator in fluid communication with the static power generator.

7. The system of claim 1, wherein the static power generator comprises:
a static charge accumulator comprising a dielectric material having a surface in contact with the flowing dielectric fluid; and
an electrical-potential storage device to receive the electrical-potential from the static charge accumulator.

8. The system of claim 7, wherein the dielectric material comprises polyvinyl chloride.

9. The system of claim 7, wherein the static charge accumulator comprises a tubular shaped member.

10. The system of claim 7, further comprising a fluid separator in fluid communication with the static power generator.

11. The system of claim 1, wherein the static power generator comprises:
a static charge accumulator comprising a dielectric material having a surface in contact with the flowing dielectric fluid;
an electrical-potential storage device to receive the electrical-potential from the static charge accumulator; and
a charge harvesting device to shunt electrical-potential from the static charge accumulator to the electrical-potential storage device.

12. The system of claim 11, wherein the dielectric material comprises polyvinyl chloride.

13. The system of claim 11, wherein the static charge accumulator comprises a tubular shaped member.

14. The system of claim 11, wherein the static charge accumulator comprises a tubular shaped member having a fluid passageway to pass the flowing dielectric fluid.

15. The system of claim 14, wherein the dielectric material comprises polyvinyl chloride.

16. A method for providing electrical power in a subterranean well, comprising:
accumulating electrical-potential in response to a dielectric fluid flowing in the subterranean well; and
providing the electrical-potential to an electrical power consuming device.

17. The method of claim 16, further comprising shunting the accumulated electrical-potential to an electrical-potential storage device.

18. The method of claim 16, further comprising:
producing a formation fluid comprising the dielectric fluid and a conductive fluid; and
separating the dielectric fluid from the conductive fluid.

19. A downhole static power generator, comprising:
a static charge accumulator comprising a dielectric material having a surface to contact a flowing dielectric fluid, wherein the static charge accumulator accumulates electrical-potential in response to the dielectric fluid flowing across the surface;
an electrical-potential storage device to receive the electrical-potential from the static charge accumulator; and
a charge harvesting device to shunt electrical-potential from the static charge accumulator to the electrical-potential storage device.

20. The downhole static power generator of claim 19, wherein the static charge accumulator comprises a tubular shaped member having a fluid passageway defined by the surface, wherein the dielectric material comprises polyvinyl chloride.
